(19) United States
(12) Patent Application Publication
(10) Pub. No.: US 2006/0049291 A1
(43) Pub. Date: Mar. 9, 2006

(54) Blade system for a shredding apparatus

(76) Inventor: David E. Rajewski, Spokane, WA (US)

Correspondence Address: WELLS ST. JOHN P.S., 601 W. FIRST AVENUE, SUITE 1300, SPOKANE, WA, 99201, US

(21) Appl. No.: 10/938,400

(22) Filed: Sep. 8, 2004

(51) Int. Cl. B02C 18/22

(52) U.S. Cl. 241/167; 241/236

(57) ABSTRACT

A shredding apparatus includes a frame and shafts driven to rotate about shaft axes. A plurality of cutter plates or blades are mounted for rotation and include stationary fingers positioned between the cutter blades, the stationary fingers including a first width and a second width.

### TECHNICAL FIELD

This invention pertains to an apparatus to provide the improved shredding of materials or feedstock and particularly to a blade system and cleaning devices used in combination with shredding blades.

### BACKGROUND OF THE INVENTION

Rotary knife or blade type shredders have been in use to shred paper and other material. One example of a mobile paper shredder is U.S. Pat. No. 5,542,617, issued to David E. Rajewski on Aug. 6, 1996, and an example of a shredding apparatus is U.S. Pat. No. 6,695,240, issued to David E. Rajewski on Feb. 24, 2004, both of which are hereby incorporated by reference into this application as though fully set forth herein.

Shredders may be provided in stationary work sites, or within trucks that have generally been referred to as mobile shredders because they can be moved from one location to another. Both forms may make use of shredding flails or knives, which are made to rotate in interleaved or intermeshing relation, some of which are relative to a stator set of anvils or cutters, or another counter rotating set of hammers or knives. Prior forms of shredders may become clogged for several reasons, such as if the infeed or input is too aggressive.

Although blade or knife shredders or shredding apparatuses are primarily discussed in this application, it will be appreciated by those of ordinary skill in the art that this invention may be utilized with any one of a number of different shredders, with no one in particular being required to practice this invention.

Feed rate to shredder blades may be influenced by upstream feeding devices such as belts, augers, feed wheels or the like; or by the cutters themselves. Self-feeding is inherent in cutter wheels with saw-type teeth in which the individual teeth have forwardly inclined hook angles. Forwardly hooked teeth tend to pull engaged materials further into the shredding cutters. If the materials to be shredded are abnormally dense, or of a tough consistency, the shredder may bog down or jam. This creates undesirable and inefficient down time for clearing the jam. Overloading also significantly reduces the useful life of the shredder drive components.

In prior shredders such as that shown in FIG. 2, the stationary fingers which have been utilized between the blades (item 123 in FIG. 2) have generally been of uniform cross-section and have typically been located close to, or tight against, the blades to prevent feedstock or other material from passing through or becoming jammed therein. The blade finders may also perform a cleaning function on the blades.

However, jams still occur and they occur because smaller feedstock or other debris still gets wedged in between the blade and the stationary finger. Furthermore, when a smaller gap is present between the stationary finger and the blade, the heat created during shredding becomes undesirably high (sometimes over two hundred degrees Fahrenheit or more), which is an undesirable condition and may lead to further problems.

Different embodiments of this invention may utilize the stationary fingers for more than one function, and which may be attached to the frame (or any other suitable location—depending on the application and the particular embodiment) to project between successive plates or blades. The stationary fingers may space the plates apart and/or may also present relatively stationary edges against which feedstock may rest or be stopped from being forced below.

There is also a need for a shredding apparatus with improved maintenance, operation at lower temperatures and reduced jams.

It is therefore an object of some embodiments of this invention to provide an improved stationary finger for use in shredding devices.

It is also an object of some embodiments of this invention to provide stationary fingers which have a relatively small or close tolerance with the blades at one location, and a relatively larger tolerance at other locations on the finger.

The above needs are fulfilled as will be understood from the following description which, taken with the accompanying drawings and appended claims, describe the best mode currently known for carrying out the present invention.

### BRIEF DESCRIPTION OF THE DRAWINGS

Preferred embodiments of the invention are described below with reference to the following accompanying drawings.

FIG. 1 is a perspective view of a shredding apparatus with portions broken away to show exemplary aspects of the invention;

FIG. 2 is a top plan schematic view of a prior art shredding apparatus utilizing blades and constant cross-section stationary fingers between the respective blades;

FIG. 3 is a perspective view showing an exemplary arrangement of blades for which stationary fingers may be utilized between respective blades or knives;

FIG. 4 and FIG. 5 are sequential views showing rotation of a pair of cutter plates during operation and progress of feedstock between the plates;

FIG. 5 is as stated above;

FIG. 6 is a perspective view of one embodiment of a stationary finger which may be utilized in this invention;

FIG. 7 is a top view of the stationary finger illustrated in FIG. 6;

FIG. 8 is a side view of the stationary finger illustrated in FIG. 6;

FIG. 9 is a top view of a shredding apparatus which includes the embodiment of the stationary fingers illustrated in FIGS. 6-8 between the blades or knives in the shredding apparatus;

FIG. 10 is detail 10 from the shredding apparatus illustrated in FIG. 9;

FIG. 11 is an alternative detail configuration showing the stationary fingers in a different location relative to the cutting blades;

FIG. 12 is an alternative detail configuration showing the stationary fingers in a different location relative to the cutting blades; and

FIG. 13 is an elevation view of another embodiment of the invention within a shredder framework.

### DETAILED DESCRIPTION OF THE PREFERRED EMBODIMENTS

Fasteners, materials, drive mechanisms, control circuitry, manufacturing and other means and components utilized to make and implement this invention are known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”

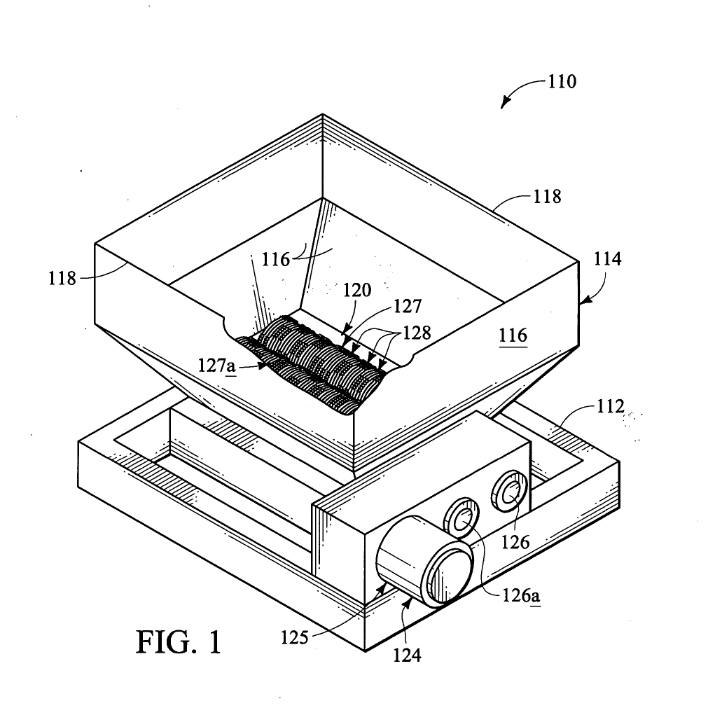

FIG. 1 illustrates a shredding apparatus 110 including exemplary aspects of the invention. The apparatus 110 may be used to shred paper and other feedstock either from a stationary location or from a support platform on a movable vehicle.

In one embodiment, the apparatus includes an input hopper 114 with an infeed end 118 and side walls 116 or other guide surface leading to a shredding station 120. Paper and other feedstock material may be manually or mechanically fed into the input hopper 114 in any one of a number of known ways, with no one in particular being required to practice this invention. It is pointed out that the apparatus may be provided with or without a hopper or other form of feed mechanism, and that different known forms of feeding arrangements may be used.

From the above, it may be understood that the term “feed” or “input hopper” as used herein is broader than its typical meaning, and without limitation, includes hoppers and any other temporary storage or containment structure for receiving the feedstock material to be shredded and for delivering the feedstock to the shredding station. Thus, the hopper may include the stationary walls 116 substantially as shown, or the walls might be defined by another form of material moving hopper construction that may directly or indirectly provide the feedstock material to the feedstock handling system for feeding to the shredder.

FIG. 1 illustrates the shredding system 110 with the exemplary hopper construction in which material is placed in the infeed end 118 and is delivered to the shredding station 120 where the material may be shredded by operation of cutters and the cutter drive generally described above and described by example below.

To provide driving energy for operation, an appropriate engine or motor may be supplied and coupled to a transmission or other appropriate drive arrangement. The cutter drive 124 may be mounted to a stationary support surface in applications where the shredder is to be used in, say a permanent shredding facility. Alternatively, the drive 124 may be mounted with the shredder apparatus connected to a vehicle power source. Such a drive arrangement could be a form of power take off or other power transmission arrangement known in the art, that makes use of an associated vehicle engine or motor for driving energy.

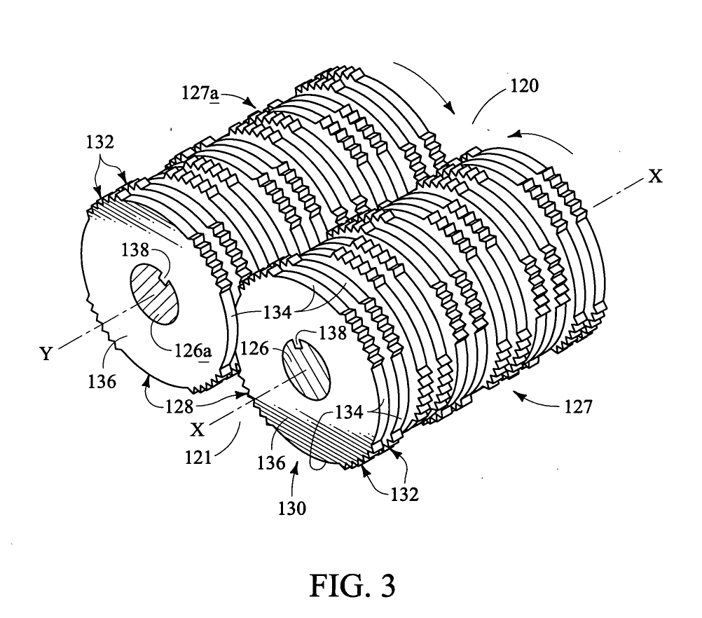

In the illustrated example, a motor and transmission arrangement 125 is provided on the frame 112 to rotate the drive shaft 126 and the second shaft 126a. It is preferred that the shafts 126, 126a be rotated by the drive in opposed directions. It is preferable that the axes X, Y (FIG. 3) of the drive shaft 126 and second shaft 126a be parallel.

Feedstock being fed into the hopper 114 may be more than might otherwise be easily or efficiently shredded by other known forms of shredding equipment. However, certain components, excess material may remain in the hopper during operation of the cutting plates and eventually be shredded without causing bogging or overloading of the drive equipment. This is a function of the plate construction and arrangement described below.

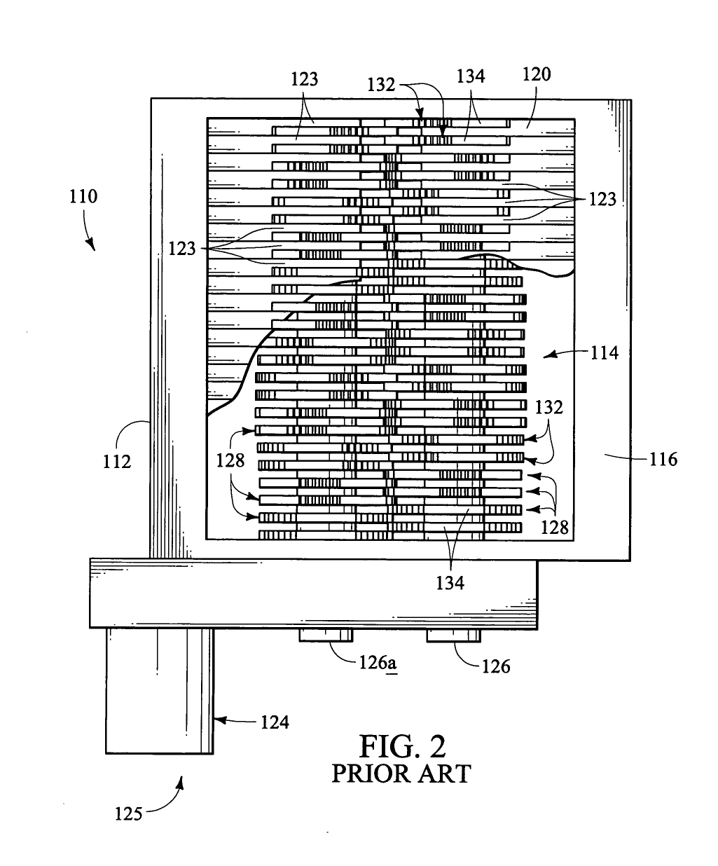

Feedstock passing through the hopper is directed to the shredding station 120 where it encounters cutter plates 128. The cutter plates function to shred and discharge the material at a discharge station 121 (shown in FIG. 2). The shredded material may drop by gravity, be forced downward by the cutting plates 128 or blades, or be otherwise collected at the discharge station 121 for further processing.

Reference will now be made to FIGS. 3-5 for further description of the exemplary cutter plates 128. Individual cutter plates 128 are preferably substantially circular in configuration and are formed of a hard, preferably metallic material such as tool steel using known metal forming processes and apparatus. References to the X and/or Y axis are shown in FIG. 3, although said axis may be referred to with regarding to other components in other figures for relative orientation, or otherwise.

It may be noted in FIG. 3 that a number of individual cutter plates 128 may be mounted in axially spaced relation along the drive shaft 126 and second shaft 126a. Appropriate spacers in the form of washers (not shown) may be provided for spacing purposes, or other appropriate spacing apparatus or technique may be used.

The plates 128 comprising the first set 127 may but need not be mounted on the drive shaft 126, and the second set 127a of cutter plates may be mounted on the second shaft 126a in interleaved, radially overlapping relation substantially as shown.

The cutter plates or blades may be provided with an appropriate form of interlock arrangement or drive shaft mount 138 by which the individual plates will rotate in direct response to rotation of the associated shaft 126 or 126a. In the illustrated example, each shaft 126 or 126a, may have successive plates 128 attached thereto using key arrangements by which the plates are locked for rotation with the respective shafts in a conventional manner. Other shaft mount or locking arrangements may also be used to secure the shafts and plates for mutual rotation.

It may be noted that axial spaces are provided in the illustrated examples between successive cutter plates 128. The amount of axial space between adjacent plates on the shaft 126 may be just slightly more than the axial thickness dimension of the individual plates, although this invention is not limited to any particular size or spacing parameters. This spacing allows for stationary fingers 123 which may be provided attached to the frame 112 to project between successive plates 128, spacing the plates apart and presenting relatively stationary edges against which feedstock may rest. These fingers may also perform a cleaning function on the blades or plates, and help prevent jamming (and/or in the case of this invention, keep the blades from rising to an undesirably high temperature).

In one exemplary form for blades, and as shown, a pair of shafts with meshing or interleaved sets 127, 127a of otherwise substantially identical cutter plates may be used in a manner similar to the example shown in FIG. 3. In the examples illustrated, two sets of cutter plates are mounted, one set to each of two shafts 126, 126a that are driven to rotate by the drive 124 (shown in FIG. 1). The shafts may be rotatably mounted by appropriate commercially known bearings to the framework and located at or at least adjacent to the bottom end of the infeed hopper 114 (shown in FIG. 1). Fingers 123 may also be used in this configuration, between adjacent cutter plates on each shaft.

In one example of a shredding apparatus in which this invention may be utilized, the shredding apparatus 110 includes a frame 112. A cutter drive 124 is provided with a drive shaft 126 mounted thereon for rotation about a drive shaft axis X. A first set of cutter plates 127 is mounted on the drive shaft 126 for rotation therewith. A second shaft 126a is also mounted to the frame for rotation about a second shaft axis Y. A second set of cutter plates 127a is mounted on the second shaft 126a for rotation therewith and is positioned in overlapping relationship with the first set of cutter plates 127. Each cutter plate 128 of both sets 127, 127a includes an outer perimeter 130 formed about the associated drive shaft axis X and second shaft axis Y. Cutter tooth groups 132 are spaced about the outer perimeter of each cutter plate 128, and cutting relief surfaces 134 are disposed between successive cutter tooth groups. The cutter tooth groups 132 are disposed on each cutter plate 128 at least partially outward of the cutting relief surfaces 134 in a radial direction with respect to the associated axis.

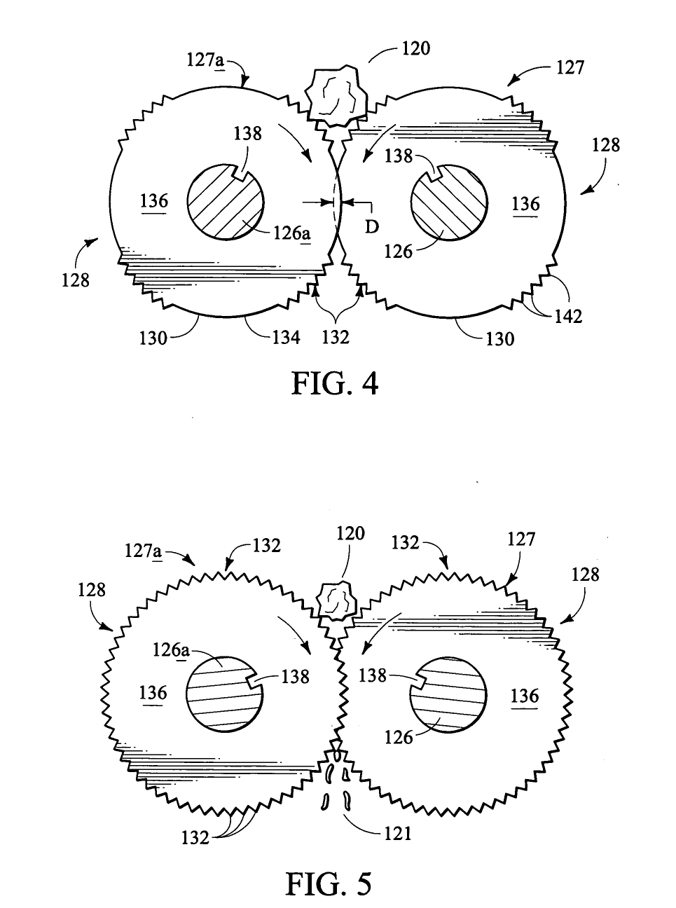

In another environment such as shown in FIG. 4, a cutter plate 128 is provided within a shredding apparatus 110 (shown in FIG. 1). The cutter plate includes a cutter plate body 136 with a shaft mount 138 substantially centered on an axis (X or Y). An outer perimeter 130 is formed about the axis (X or Y), and cutter tooth groups 132 are spaced thereabout. Cutting relief surfaces 134 are provided along the outer perimeter 130. The surfaces 134 are disposed between successive cutter tooth groups 132. The cutter tooth groups 132 project outward in a radial direction with respect to the axis (X or Y).

A further aspect of the invention includes a shredding apparatus cutter plate 128 which comprises a cutter plate body 136 with a shaft mount 138 for releasable attachment to a shaft (126 or 126a) for rotation therewith about an axis (X or Y). An outer perimeter 130 formed about the axis (X or Y) and cutter tooth groups 132 are formed integrally with the cutter plate body 136 at spacing that is approximately equiangular about the outer perimeter. A succession of cutting relief surfaces 134 are formed as arcs with approximate centers at the axis (X or Y). The cutting relief surfaces 134 are disposed between successive cutter tooth groups 132. The cutter tooth groups 132 project radially outward with respect to the axis (X or Y) from the cutting relief surfaces. Each cutter tooth group is comprised of a number of individual cutter teeth 142 and at least some of the cutter teeth 142 are substantially triangular in configuration. Each tooth 142 includes a base 144 along the cutter plate. The base 144 is spaced from the shaft axis (X or Y) by a distance substantially equal to radial spacing from the shaft axis (X or Y) to the cutting relief surfaces 134.

In a further aspect the shredding apparatus 110 includes a frame 112 and a cutter drive 124 including a drive shaft 126 and a second shaft 126a, located adjacent a shredding station 120 for rotation in opposed directions about shaft axes X and Y. A first set of cutter plates 127 is mounted on the first drive shaft 126 for rotation therewith. A second set of cutter plates 127a are mounted on the second drive shaft 126a for rotation therewith and in axial interleaved relation with the first set of cutter plates 127. Each individual cutter plate 128 includes an outer perimeter 130 formed about the associated shaft axis (X or Y). Cutter tooth groups 132 and cutting relief surfaces 134 are spaced about the outer perimeters of at least some of the cutter plates. The cutter tooth groups 132 are angularly disposed about the associated axis (X or Y) such that a cutter tooth 142 on one cutter plate 128 is in approximate axial alignment with a cutting relief surface 134 on another cutter plate 128 that is mounted to the same shaft 126 or 126a.

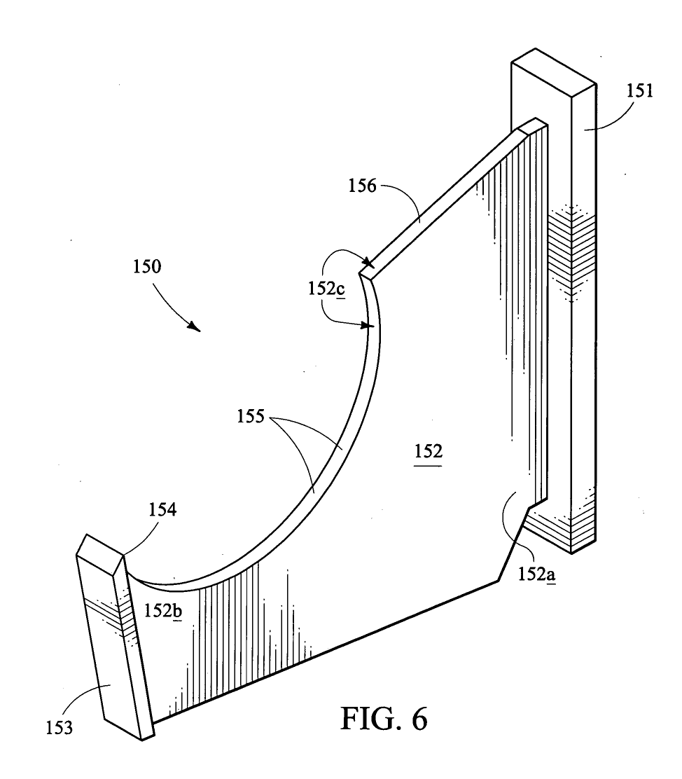

FIG. 5 shows another of the many examples of blades or cutter plate tooth patterns which may be in a shredder apparatus in which this invention is utilized, with no one in particular being required to practice this invention.

In the illustrated example of the stationary finger in FIG. 2, the finger has an approximate constant cross sectional area and distance or spacing from each blade between which the finger is situated. This has been found to result in excessive heat and higher jamming than is believed will be achieved with this invention.

FIG. 6 is a perspective view of an embodiment of a stationary finger 150 which may be utilized by this invention, illustrating a finger body 152 with a first end 152a and a second end 152b, a top edge 152c, which is also a leading edge 152c as it relates to feedstock coming through the blades or plates. In the embodiment shown, the top edge 152c has a generally arcuate portion 155 and a generally sloped portion 156. It will be appreciated by those of ordinary skill in the art that no specific shape or configuration of the top or leading edge of the finger body 152 is required to practice this invention.

FIG. 6 further illustrates that the first end of the finger body is attached to a frame coupler 151 which may be utilized to attach or secure the finger 150 to a frame or framework of the shredder or hopper. It will be appreciated by those of ordinary skill in the art that while such a frame coupler 151 may be used (with no particular configuration required), it is not necessary to practice the invention and the finger body 152 may be otherwise attached directly or indirectly to a framework or other component.

At the second end 152b of the finger 150 is a cleaning ram 153, which may be considered part of or separate from the finger body 152. The ram 153 is wider than the finger body 152, as will be discussed relative to later figures, and includes a leading edge 154 (which may, but need not, be used in all embodiments of this invention).

While the ram 153 is shown at the end of the finger 150, it need not be for purposes of all embodiments of this invention, but instead may be at an intermediate location on the finger body, with no particular location being required. It is preferred but not required however that it be toward the second end 152b.

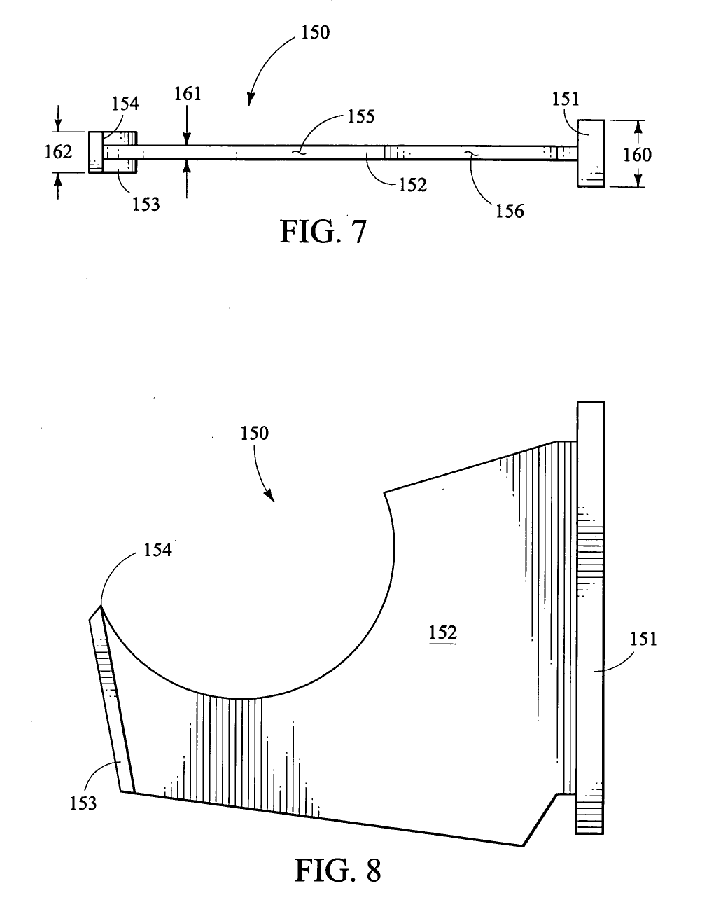

FIG. 7 is a top view of the finger 150 illustrated in FIG. 6, and shows the finger body 152 with the generally arcuate portion 155 and generally sloped portion 156 of the top edge of the finger body 152. FIG. 7 shows width 161 of finger body 152, width 162 of ram 153 with leading edge 154. The frame coupler 151 has width 160.

FIG. 8 is a side view of the finger 150 illustrated in FIG. 6, and shows the finger body 152, ram 153 with leading edge 154 and frame coupler 151.

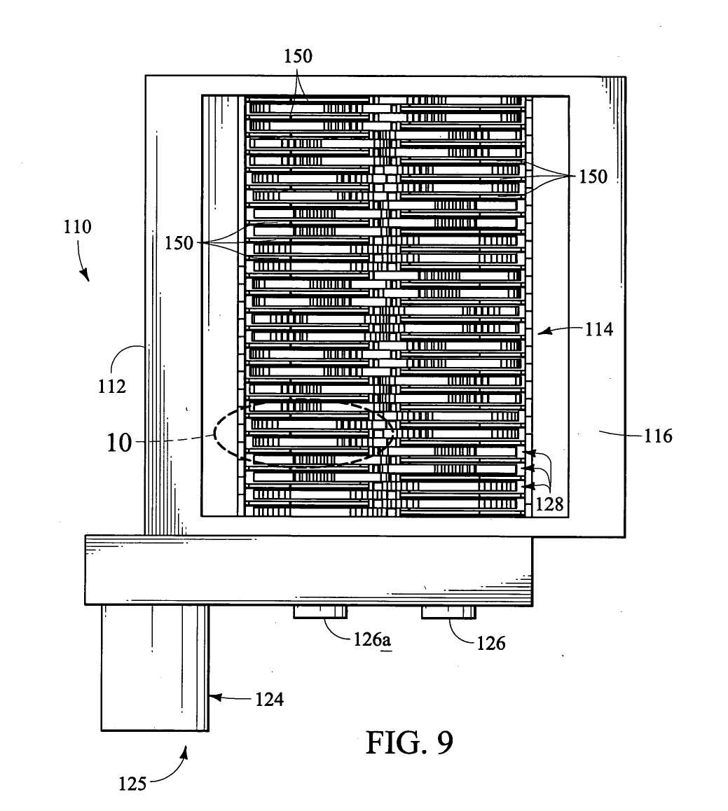

FIG. 9 is a top view of an exemplary shredding apparatus 110 with plates 150 or blades with the embodiment of the fingers 150 between the respective blades 128. The other items are numbered as set forth above, show an exemplary shredding apparatus, and each will not be separately identified, labeled or numbered here.

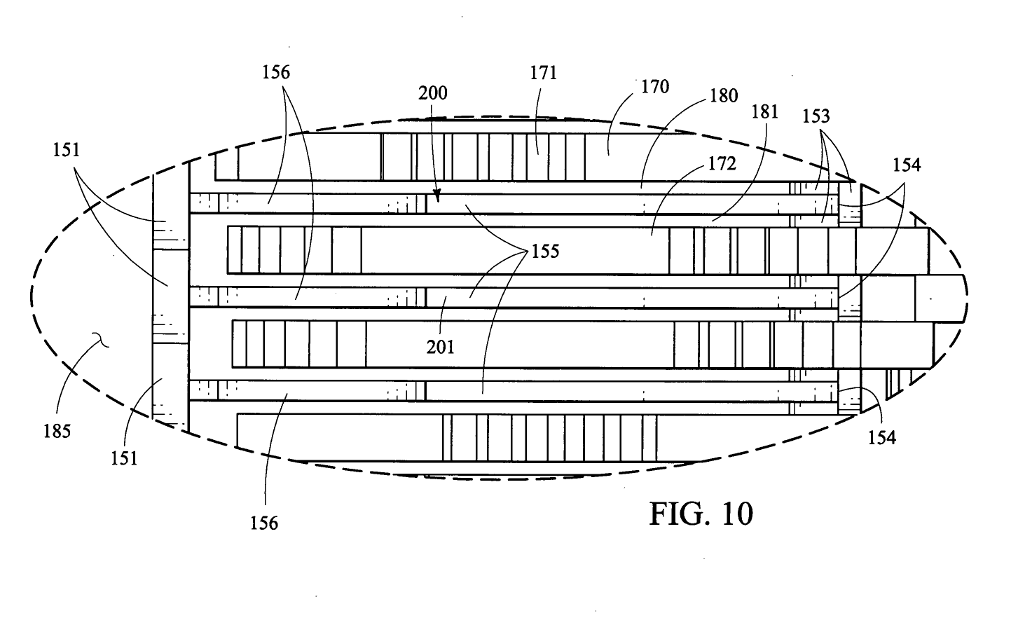

FIG. 10 is detail 10 from FIG. 9, and illustrates in more detail an embodiment of this invention wherein fingers are positioned within blades in a shredding apparatus. FIG. 10 illustrates three fingers positioned between blades or plates. For example first cutting blade 170 has cutting teeth 171 and is configured to rotate as shown in earlier figures. A first finger 200 is positioned between first cutting blade 170 and second cutting blade 172. The first finger 200 and second finger 201 both generally include an arcuate portion 155 and a generally sloped portion 156 along the upper edge, frame couplers 151, ram portions 153 with leading edges 154. The ram portions 153 may (but need not) rub on the adjacent blades between which they are located, and when combined with the thinner body portion of the finger, provide a first air gap 180 and a second air gap 181. The combination of the wider ram portions 153 with the air gaps 180 & 181, provide an improved shredder which operates at lower temperatures.

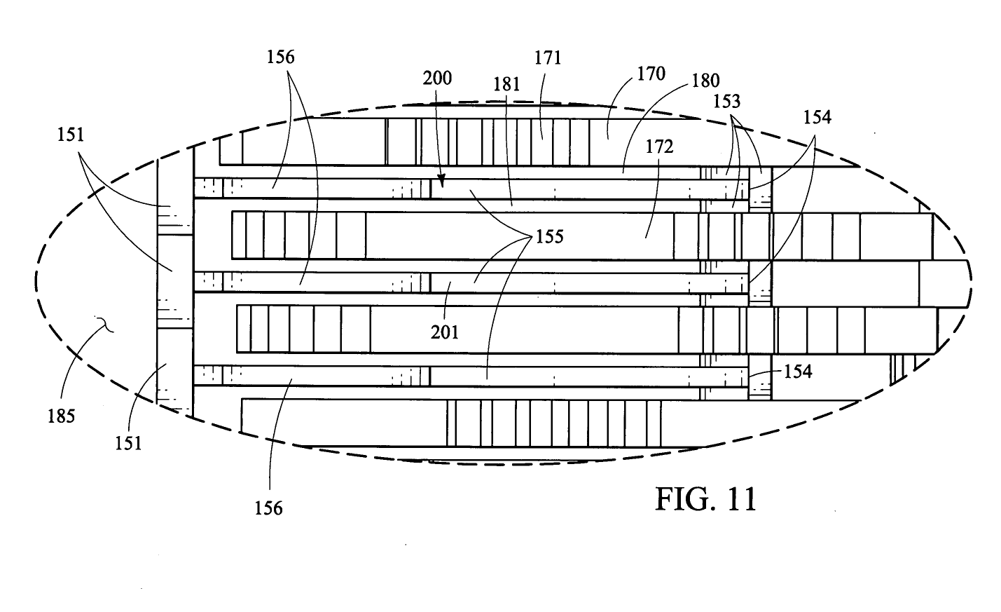

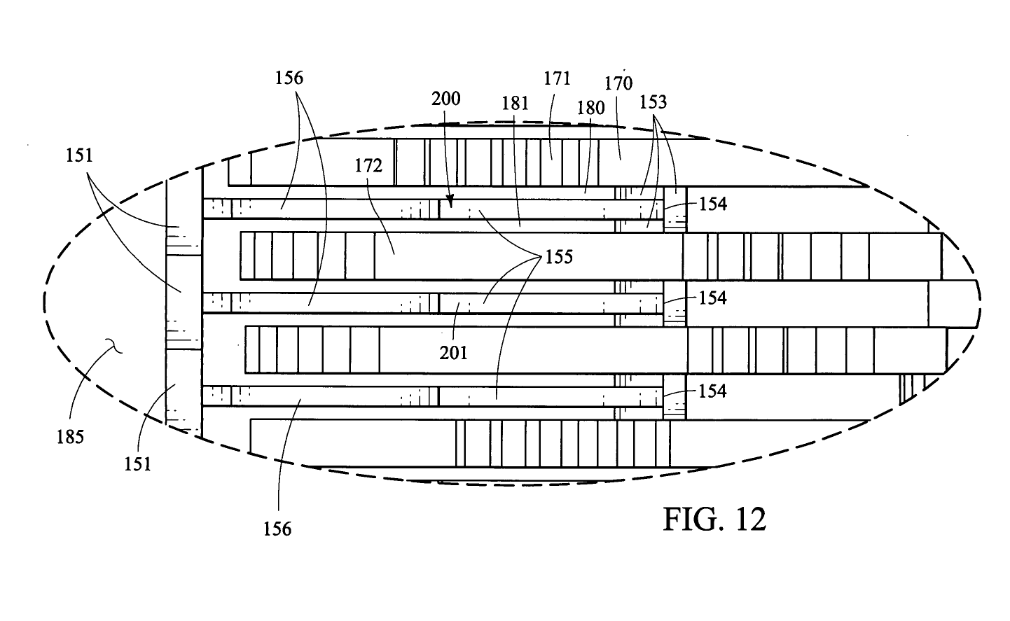

FIGS. 11 and 12 are alternative detail configurations showing the stationary fingers in a different location relative to the cutting blades, to illustrate that there are many possibilities for the relative location of the stationary fingers relative to the cutter blades. The same item numbers have been used for the same components as shown and described with respect to FIG. 10, and each will not therefore be repeated here.

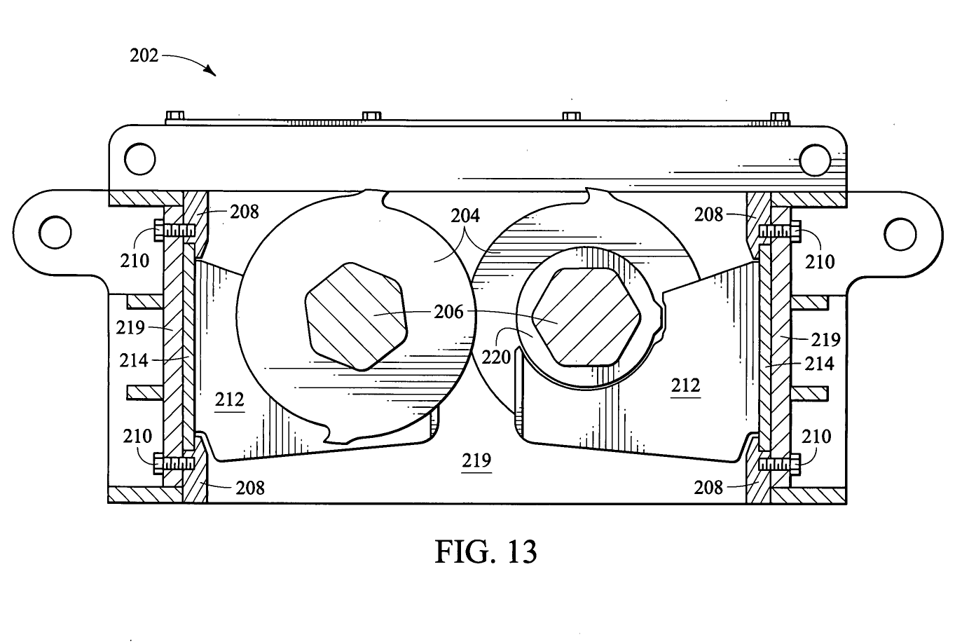

FIG. 13 is an elevation view of another possible embodiment of the invention within a shredder framework 219. FIG. 13 illustrates shredder apparatus 202 with cutter blades 204 (or cutter plates), axle 206, spacer 220, stationary fingers 212, frame couplers 214 removable attached to the framework by bolts 210 through the framework 219 and into brackets 208. In the embodiment shown, the frame couplers 214 are removable secured to the framework 219 to allow for easy removal and replacement.

The spacers 220 are used to space or locate the cutting blades 204 relative to each other and/or relative to the stationary fingers 212.

It is preferred that the shafts be rotated in opposed directions in order to engage and shred materials received in the hopper. Appropriate known forms of gearing or other drive transmission may be provided for this purpose. The shafts preferably rotate in the direction indicated in FIG. 5, so that feedstock in the hopper is engaged as indicated above and progressively shredded between successive cutter plates 128.

While there are many different drive gearing and other arrangements which may be used to provide the rotation to the drive shafts 126, no one in particular is required to practice the invention. The preferred arrangement generally shown in FIGS. 1 and 2 are merely one example within the contemplation of this invention. No particular drive shaft revolutions per minute are required to practice this invention, although the clog preventing features of these stationary fingers may allow the drive shafts to be operated at speeds greater than previously thought capable in other shredders.

In operation, feedstock is deposited into the hopper following actuation of the drive to initiate rotation of the drive shafts 126, 126a and the cutter plates mounted thereon. Feedstock is directed toward the rotating cutter plates and is sporadically engaged by the cutter tooth groups as the shafts rotate. The cutter teeth in the example shown, shear and shred the engaged material against one another in a rapid but broken sequence so that no binding or jamming of the cutters is likely to occur. Thus the rotating cutters will shred the feedstock progressively and discharge the shredded material out the bottom of the apparatus where it may be collected for further handling.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A shredding apparatus, comprising:
a frame;
a cutter drive on the frame including a drive shaft mounted to the frame for rotation about a drive shaft axis;
a first set of cutter plates mounted on the drive shaft for rotation therewith;
a second shaft mounted to the frame for rotation about a second shaft axis;
a second set of cutter plates mounted on the second shaft for rotation therewith and positioned in overlapping relationship with the first set of cutter plates;
a finger positioned between two adjacent cutter plates within the first set of cutter plates, the finger comprising:
an elongated finger body with a first end and a second end, the first end being configured for attachment to the shredding apparatus and the second end being positioned between two adjacent cutter plates with an air gap between the finger body and each of the two adjacent cutter plates; and
a ram operatively attached toward the second end of the finger body between the two adjacent cutter plates, the ram having a ram width greater than a width of the finger body.

2. A shredder apparatus as recited in claim 1, and further wherein the ram is attached to the end of the finger body.

3. A shredder apparatus as recited in claim 1, and further wherein the ram width is substantially the same as a distance between the two adjacent cutting plates.

4. A finger for positioning between two adjacent cutter plates in a shredding apparatus, the shredding apparatus including a first cutter plate and a second cutter plate, with a finger gap between, the finger comprising:
an elongated finger body with a first end and a second end, the first end being configured for attachment to the shredding apparatus and the second end being positioned between two adjacent cutter plates with an air gap between the finger body and each of the two adjacent cutter plates; and
a ram operatively attached toward the second end of the finger body between the two adjacent cutter plates, the ram having a ram width greater than a width of the finger body.

5. A finger as recited in claim 4, and further wherein the ram is attached to the end of the finger body.

6. A finger as recited in claim 4, and further wherein the ram width is substantially the same as a distance between the two adjacent cutting plates.
